(19) United States
(12) Patent Application Publication
(10) Pub. No.: US 2010/0279640 A1
(43) Pub. Date: Nov. 4, 2010

(54) CONFIGURING RADIOS

(75) Inventors: Kevin M. Bryan, Fort Wayne, IN (US); Timothy D. Kendall, Churubusco, IN (US); John K. Whiteman, Yoder, IN (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(73) Assignee: Raytheon Company, Waltham, MA (US)

(21) Appl. No.: 12/769,824

(22) Filed: Apr. 29, 2010

Related U.S. Application Data
(60) Provisional application No. 61/174,634, filed on May 1, 2009.

(51) Int. Cl. H04B 7/00

(52) U.S. Cl. 455/230

(57) ABSTRACT

In one aspect, a method includes using a processor to receive a request to configure a first radio having a first type. Using the processor includes using the processor to obtain a first configuration type used to configure the first radio and to configure a first radio using the first configuration type.

### RELATED APPLICATIONS

This application claims priority to provisional application Ser. No. 61/174,634, entitled “CONFIGURING RADIOS,” filed May 1, 2009, which is incorporated herein in its entirety.

### BACKGROUND

A radio used in two-way communications may be required to be reconfigured. For example, encryption keys need to be updated to ensure that the radio can decode messages received by other radios. Typically, radios arc manually configured by a user, which can be confusing and/or burdensome to the user.

### SUMMARY

In one aspect, a method includes using a processor to receive a request to configure a first radio having a first type. Using the processor includes using the processor to obtain a first configuration type used to configure the first radio and to configure a first radio using the first configuration type.

In another aspect, an article includes a machine-readable storage medium that stores executable instructions to configure radios. The executable instructions cause a machine to receive a request to configure a first radio having a first type, obtain a first configuration type to configure the first radio and configure a first radio using the first configuration type.

In a further aspect, a radio configuration module includes an application program interface configured to receive radio configuration requests for a plurality of radio types from a host application, a storage medium to store configuration types corresponding to the plurality of radio types and a processor configured to receive the radio configuration requests and to configure radios based on the configuration types stored in the storage medium.

### DESCRIPTION OF THE DRAWINGS

FIG. 1 is a functional block diagram of a radio configuration environment including a radio configuration module.

FIG. 2 is a flowchart of an example of a process to configure radios.

FIG. 3 is an example of an architecture for the radio configuration module.

FIGS. 4A to 4G are sequence diagrams showing examples of different functions performed by the architecture of FIG. 3.

FIG. 5 is a block diagram of an example of a computer on which the process of FIG. 2 may be implemented.

### DETAILED DESCRIPTION

Graphical software has been developed that can configure a radio, but a graphical user interface (GUI) that is provided in the prior art requires user interaction to set-up a radio configuration. As described herein an easy-to-use interface for host applications may be used to configure and control multiple different radio types through an application interface (API) or a user interface and may also be used to control multiple radios from the same application instance at distances greater than the normal physical radio interface would allow. By adding remote API control to a standard application, multiple radio functionality may be provided to the host computer applications.

In one example, described herein is an approach that includes an interface (e.g., a radio configuration module 20) for host applications (e.g., a host application 16) to configure and to control multiple different radio types (e.g., radio types 24a-24c) through an application interface (API) (e.g., API 28) or through the API 28 via a graphical user interface (GUI) 18.

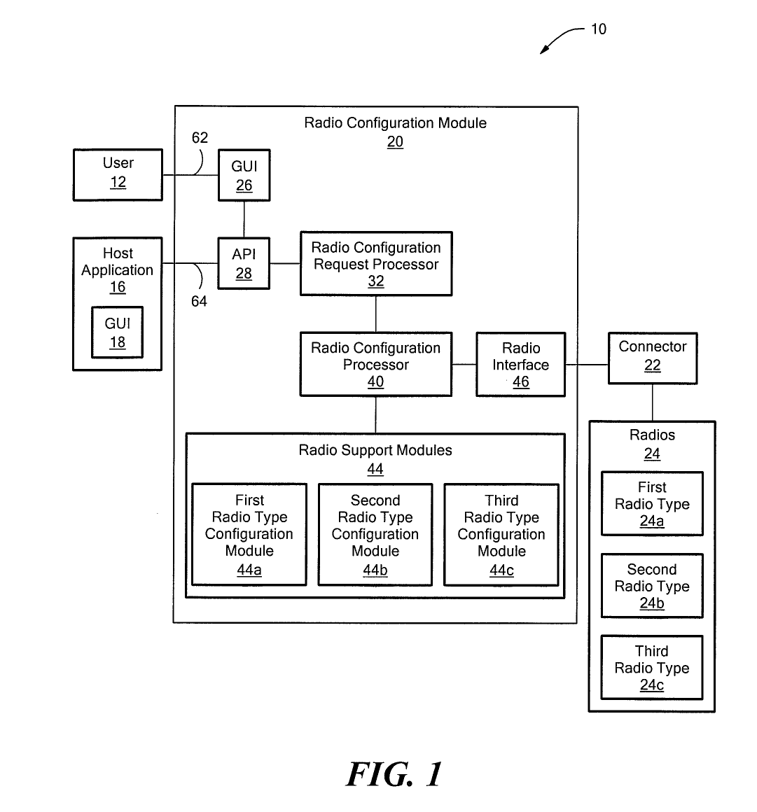

Referring to FIG. 1, in one example, a radio configuration environment 10 includes a user 12, a host application 16 including a graphical user interface (GUI) 18, a radio configuration module 20, a connector 22 and radios 24 (e.g., a first radio type 24a, a second radio type 24b and a third radio type 24c). In one example, the radios 24 include one or more of a PRC-117F radio, a PRC-152 radio and a PRC-148 radio. In a further example, the radios 24 may be SINCGARS (Single Channel Ground and Airborne Radio System) radios. In a further example, the radios 24 may be Fire Series Radios manufactured by Raytheon Company of Waltham, Mass. such as PSC-5 Series Radios and ARC-231 Series Radios, for example.

In one example, the radio configuration module 20 includes a GUI 26, an application program interface 28, a radio configuration request processor 32, a radio configuration processor 40, radio support modules 44 (e.g., a first radio type configuration module 44a, a second radio type configuration module 44b and a third radio type configuration module 44c) and a radio interface 46. In other examples, the radio configuration module does not include the GUI 26.

In one particular example, the first radio type configuration module 44a configures the first radio type 24a, the second radio type configuration module 44b configures the second radio type 24b and the third radio type configuration module 44c configures the third radio type 24c.

The radio configuration module 20 is configured to receive radio configuration requests from either the user 12 through the GUI 26 to the API 28 or the host application 16 through the API 28 or both the user 12 and the host application 16. In one example, either the user 12 or the host application 16 or multiple users (not shown) or multiple host applications (not shown) or any combination thereof may configure one or more radio types 24a-24c. In one example, the user 12 has an option of using the GUI 18 or the GUI 26 to configure radios 24. In particular, the user 12 could use GUI 26 as a replacement for the GUI 18 of host application 16, or use the GUI 18 of the host application 16 access the capabilities of the support modules 44 directly through the API 28.

The user 12 is connected to the GUI 26 by a connection 62 and the host application 16 is connected to the API 28 by a connection 64. One or both of the connections 62, 64 may be a wide area network connection, a local area network connection, an Internet connection and so forth, so that the user 12 and the host application 16 do not have to be physically located (e.g., within a few feet) with the radio configuration module 20. Thus, multiple radios 24 may be controlled from one application instance (e.g., a host application 16) at distances greater than the normal physical radio interface (e.g., a connector 22) would allow. In some examples, the radio configuration module 20 may be used which can either be the same or different than a system that includes the host application 16 which accesses the API 28.

In one example, the configuration request is a request to configure one radio. In another example, a configuration request is a request to configure multiple radios, for example, multiple radios of different types. In one example, more than one host application (not shown) may be used to access the API 28 to provide the radio configuration requests.

The radio configuration request processor 32 validates the radio configurations requests and provides the configuration requests to the radio configuration processor 40. The radio configuration processor 40 obtains the radio support module 44 corresponding to the configuration request from the radio support modules 44 and provides the corresponding configuration to the radio interface 46 through the connector 22 to configure the corresponding radio(s) 24. The connector 22 connects the radio configuration module 20 to the radios 24. In one example, the connector 22 is a cable (e.g., a TacLink® 3300 cable).

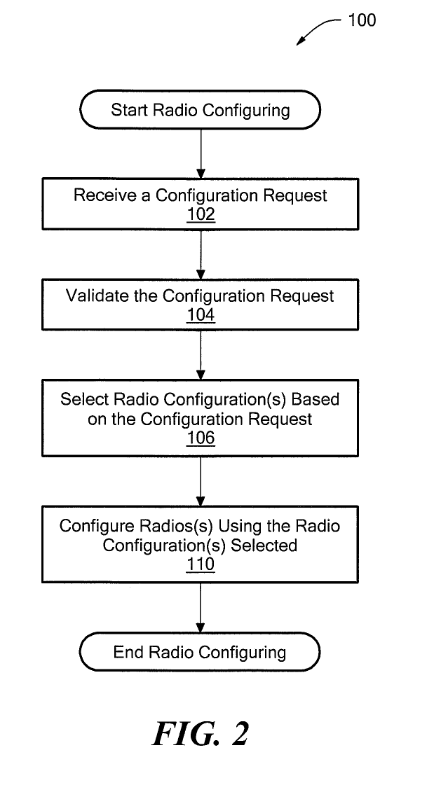

Referring to FIG. 2, an example of a process to configure radios is a process 100. A configuration request is received (102). For example, the radio configuration module 20 receives a configuration request from the user 12 and/or the host application 16. The configuration request is validated (104). For example, the radio configuration request processor 32 validates the radio configuration request.

One or more radio configurations modules 44 are selected based on the configuration request (106). For example, one or more of the radio support modules 44a-44c are selected that correspond to the radio request. In one particular example, the configuration request is to configure a first radio type 24a so that the corresponding support module is a first radio type configuration module 44a. In another example, the configuration request may include more than one radio type so that multiple corresponding support modules 44a-44c are obtained. The radio(s) is configured using the radio type configuration modules 44 selected (110).

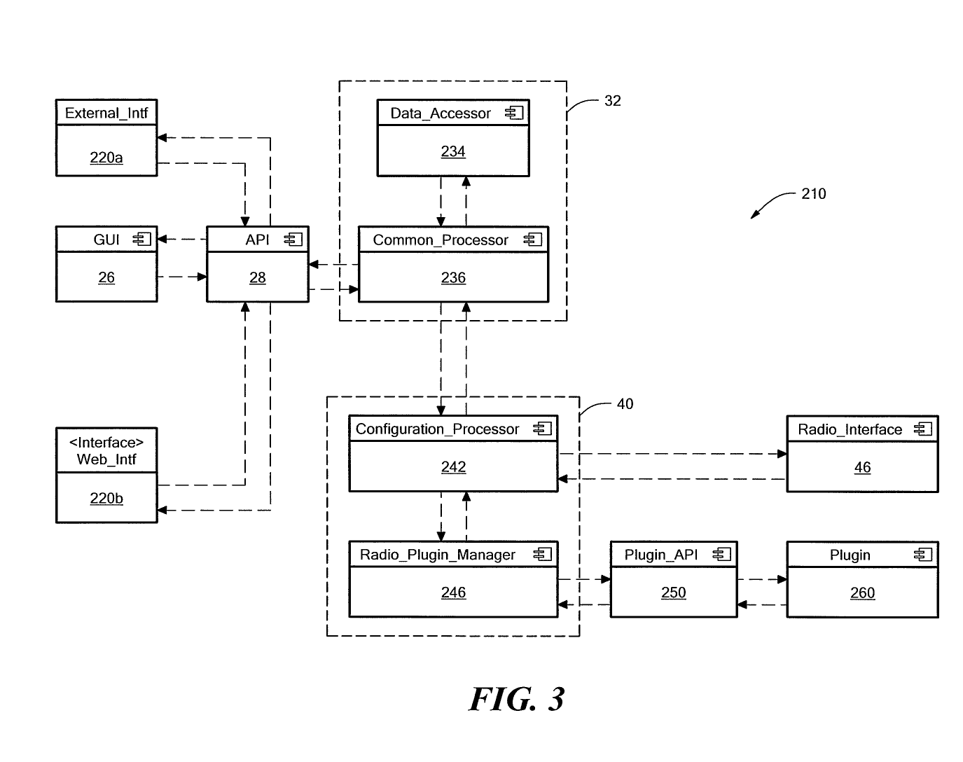

Referring to FIG. 3, an example of an architecture for the radio configuration module is the architecture 210. The architecture 210 includes the GUI 26, the API 28, the radio configuration request processor 32, the radio configuration processor 40, the radio interface 46. The architecture 210 also may include other interfaces than the GUI 26 to interface with the API 28 such as an external interface 220a and a web interface 220b. In one example, the external interface 220a is a host application 16.

The configuration request processor 32 includes a data accessor 234 configured to obtain and store configuration data and a common processor 236 configured to multiplex commands and route the commands to appropriate subcomponents and is also configured to validate command parameters before processing. The radio configuration processor 40 includes a configuration processor 242 configured to validate and route configuration(s) to the radio 24 and a radio plug-in manager 246 configured to manage expandable plug-ins. The architecture 210 further includes a plug-in API 250 to interface with the radio plug-in manager 246.

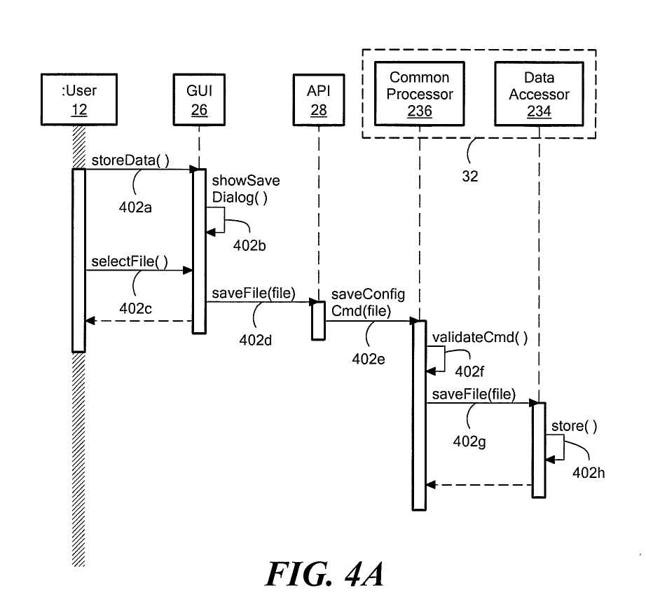

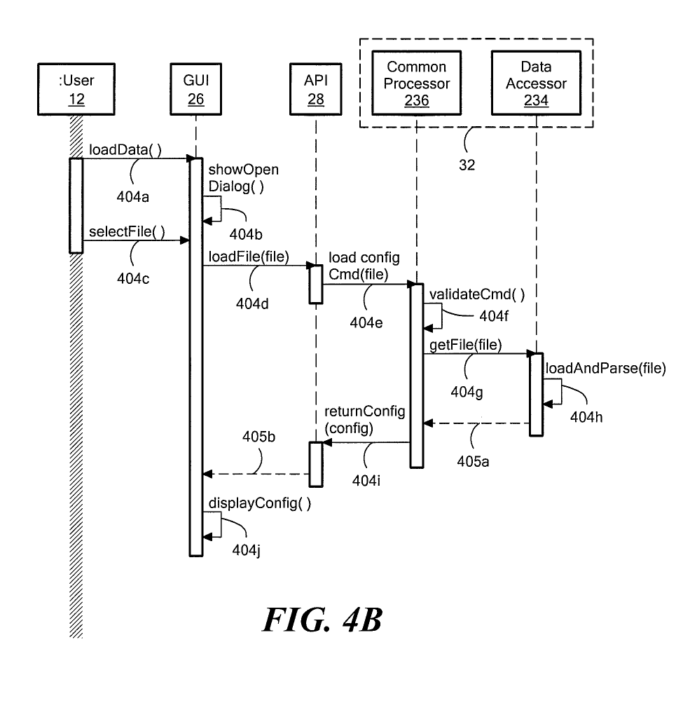

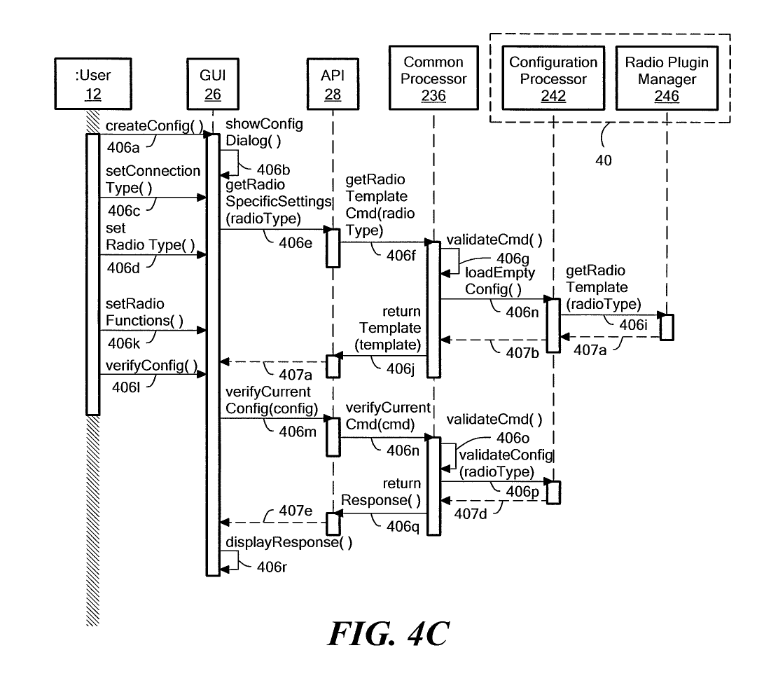

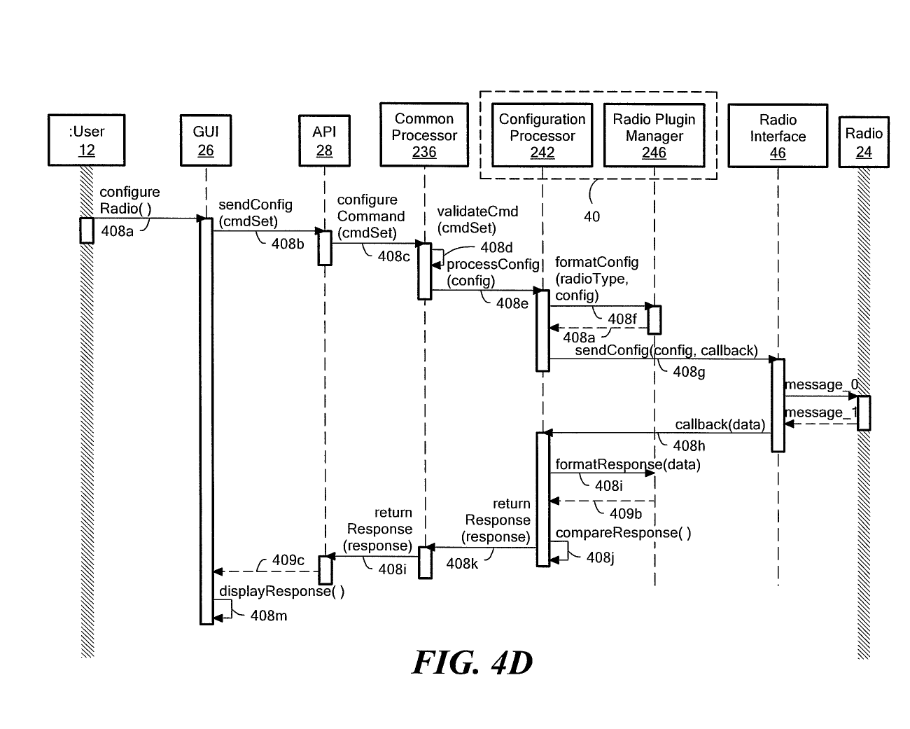

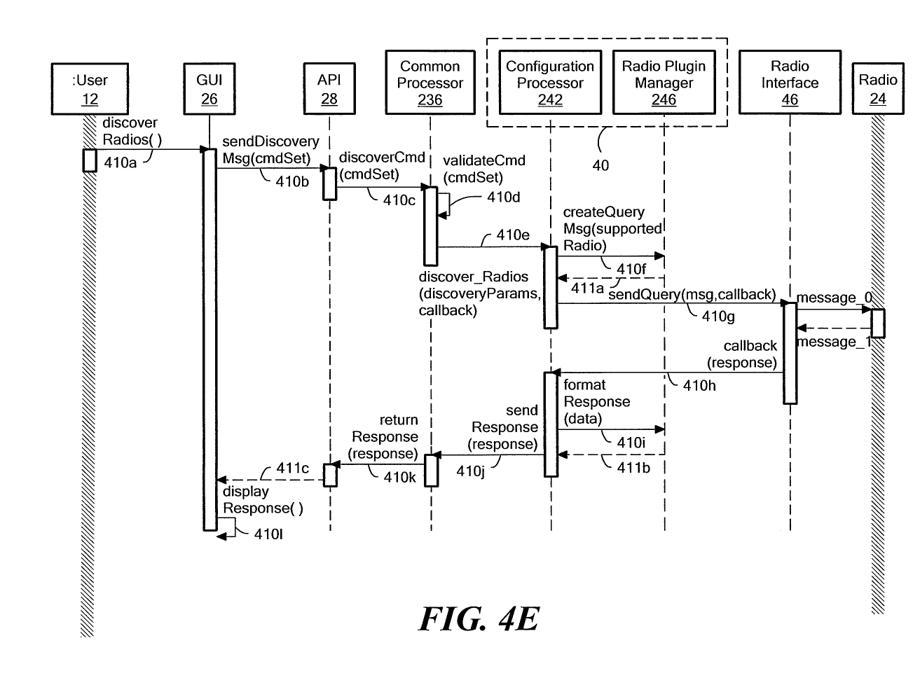

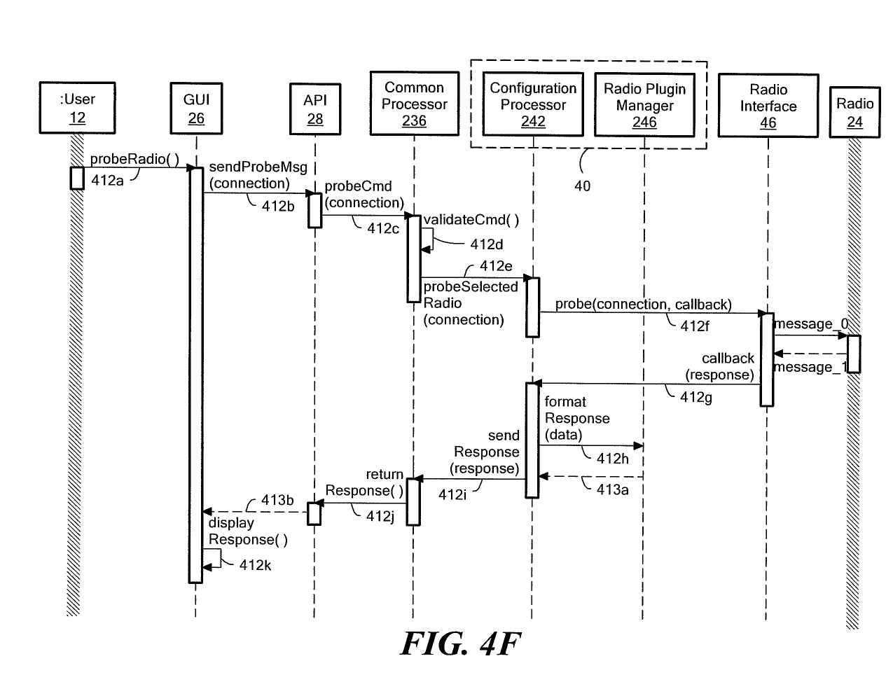

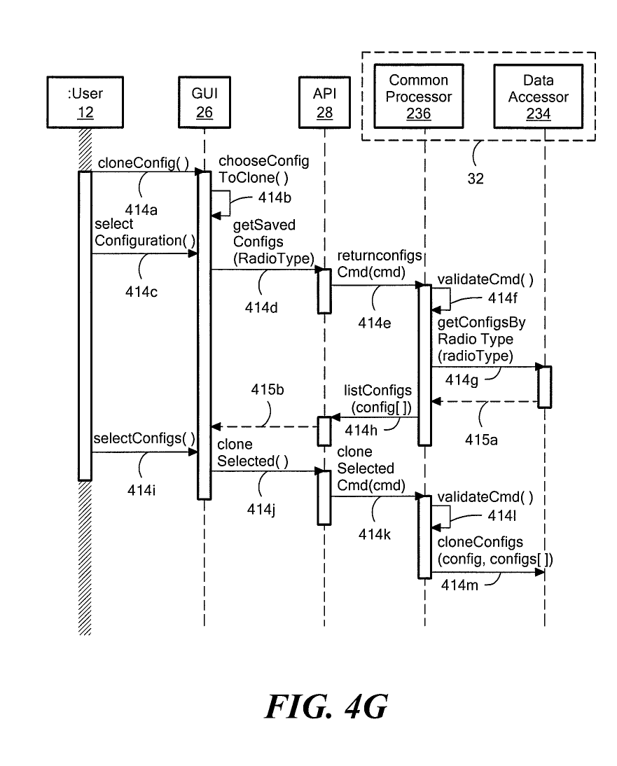

Referring to FIGS. 4A to 4G, the architecture 210 is capable of performs numerous functions. For example, the architecture 210 may be used to save, load and generate configuration data files as well as configuring radios. The architecture 210 may also be used to discover a radio network, probe a radio and copy a radio preset. While the description of the sequence diagrams in FIGS. 4A to 4G shows the user 12 as initiating a particular sequence, the user 12 and the GUI 26 may be replaced by the host application 16 or the host application and the GUI 18.

FIG. 4A depicts one example of a sequence to save configuration data files. For example, the user 12 sends a request to store data to the GUI 26 (402a). The GUI 26 displays a dialog box of configuration data files to save (402b) and the user 12 selects a configuration data file to save (402c). The GUI 26 sends a save file message for the configuration data file selected by the user 12 to the API 28 (402d). The API 28 sends a save configuration command for the configuration data file to the common processor 236 (402e). The common processor 236 validates the save configuration file (402f) (e.g., validates parameters). The common processor 236 send a save file command for the file to be saved to the data accessor 234 (402g). The data accessor 234 stores the configuration data file (402g).

FIG. 4B depicts one example of a sequence to load or access configuration data files. The user 12 sends a request to load configuration data to the GUI 26 (404a). The GUI 26 provides a list of configuration data files (404b). The user 12 selects a configuration data file to load (404c). The GUI 26 sends a request to load the configuration data file to the API 28 (404d). The API 28 sends a command to load the configuration data file to the common processor 236 (404e). The common processor 236 validates the command sent by the API 28 (404f) (e.g., validates parameters). The common processor 236 sends a command to obtain the configuration data file to the data accessor 234 (404g). The data accessor 234 loads and parses the configuration data file (404h). The common processor 236 returns the configuration data selected by the user to the API (404i) based on receipt from data accessor 234 (405a). Based on receipt from the API 28 (405b), the data configuration selected by the user 12 is displayed by the GUI 26 (404j).

FIG. 4C depicts one example of a sequence to generate a radio configuration. The user 12 sends a request to create a configuration file to the GUI 26 (406a). The GUI 26 provides a dialog box to the user to select configuration parameters (406b). The GUI 26 provides various configuration parameters to the user 12 such as connection type, radio type and so forth. The user 12 selects and sends to the GUI 26 a connection type (406c) and radio type (406d). The GUI 26 request radio specific setting based on the radio type selected by the user 12 from the API 28 (406e). The API 28 sends a command to obtain the radio template based on the radio type selected by the user 12 to the common processor 236 (406f). The common processor 236 validates the command to obtain the radio template (406g) (e.g., validates parameters). The common processor 236 sends a request to the configuration processor 242 to load an empty radio configuration template (406h). The configuration processor 242 obtains the radio configuration template from the radio plug-in manager 246 (406i).

The radio configuration template is sent to the configuration processor 242 (407a) and to the common processor (407b). The common processor 236 returns the radio template to the API 28 (406j) and to the GUI 26 (407c).

The user 12 uses the template to select and send the radio functions to the GUI 26 (406k). The user 12 sends a verification request of the configuration to the GUI 26 (406l). The GUI 26 sends a verify current configuration command to the API 28 (406m). The API 28 sends a verify configuration command to the common processor 236 (406n). The common processor 236 validates the verify configuration command (406o) (e.g., validates parameters). The common processor 236 send a validate configuration command to the configuration processor 242 (406p). The common processor 236 receives a validation response from the configuration processor (407d) and sends a return response to the API 28 (406q). After the GUI 26 receives the return response from the API 28(407e), the GUI 26 displays the response to the configuration verification (406r).

FIG. 4D depicts one example of a sequence to configure a radio. The user 12 sends a request to configure a radio to the GUI 26 (408a). The GUI 26 sends a radio configuration request to the API 28 (408b). The API 28 sends a configuration command to the common processor 236 (408c). The common processor 236 validates the configuration command sent by the API 28 (408d) (e.g., validates parameters). The common processor 236 sends a command to the configuration processor 242 to process the configuration selected (408e). The configuration processor 242 sends a request to the radio plug-in manager 246 for the format and configuration based on the radio type.

After the configuration processor 242 receives the format and radio configuration from the radio plug-in manager 246 (409a), the configuration processor 242 sends the configuration data to the radio interface 46 to configure the radio 24 (408g) (e.g., sending a message (message_{—}0) to the radios 24 and receiving a return message (e.g., message_{—}1) from the radio). The radio interface 46 sends a callback response to the configuration manager 242 (408h). The configuration processor 242 sends a format response message to the radio plug-in manager 246 (408i). After receiving a response from the radio plug-in manager 246 (409b), the configuration processor 242 compares the response (408j) and sends a response to the common processor 236 (408k). The configuration processor 236 sends a return response to the API 28 (408l). After receiving the return response from the API 28 (409c), the GUI 26 displays the response (408m).

FIG. 4E depicts one example of a sequence to discover a radio network. The user 12 sends a request to the GUI 26 to discover radios (410a). The GUI 26 sends a discovery message to the API 28 (410b). The API 28 sends a discover command to the common processor 236 (410c). The common processor 236 validates the discover command (410d) (e.g., validates parameters). The common processor 236 sends a query message to the configuration processor 242 to determine supported radios (410e). The configuration processor 242 sends a message to create a query message 410f to the radio plug-in manager 246. After the configuration processor 242 receives the supported radios from the radio plug-in manager 246 (411a), the configuration processor 242 sends a query message to the radio interface 46 to communicate with the radios 24 (e.g., sending a message (message_{—}0) to the radios 24 and receiving a return message (e.g., message_{—}1) from the radios). The radio interface 46 sends a callback response to the configuration manager 242 (410h). The configuration processor 242 sends a format response message to the radio plug-in manager 246. After receiving a response from the configuration manager (411b), the configuration processor 242 sends a response to the common processor 236 (410j) and the configuration processor 236 sends a return response to the API 28 (410k). After receiving the return response from the API 28 (411c), the GUI 26 displays the response (410l).

FIG. 4F depicts one example of a sequence to probe a radio. The user 12 sends a probe radio request to the GUI 26 (412a). The GUI sends a probe radio message to the API 28 (412b). The API 28 sends a probe radio command to the common processor 236 (412c). The common processor 236 validates the radio probe command (412d) (e.g., validates parameters). The common processor 236 sends a message to the configuration processor 242 to probe a radio selected by the user 12 (412e). The configuration processor 242 send a message to the radio interface 46 to probe the selected radio (412f). The radio interface 46 probes the selected radio, for example, by sending a message (message_{—}0) to the radio 24 and the radio 24 returns a message (message_{—}1). The configuration processor 242 receives the callback response from the radio interface (412g). The configuration processor 242 sends a format response message to the radio plug-in manager 246 (412h). After the configuration processor 242 receives a response from the radio plug-in manager 246 (413a), the configuration processor 242 sends a response to the common processor 236 (412i). The common processor 236 sends a return response to the API 28 (412j). After the GUI 26 receives the return response from the common processor 236 (413b), the GUI 26 displays the response (412k).

FIG. 4G depicts one example of a sequence to copy a radio preset. The user 12 sends a clone request to the GUI 26 (414a). The GUI 26 displays radio configurations to clone (414b). The user 12 sends to the GUI 26 a radio configuration selection (414c). The GUI 26 sends a message to the API 28 to obtain saved radio configurations (414d). The API 28 sends a command to the common processor 236 to return saved radio configurations (414e). The common processor 236 validates the command to return saved configuration (414f) (e.g., validates parameters). The common processor 236 obtains the configuration by radio type from the data accessor 234 (414g). After the data accessor 235 sends the configurations by radio type to the common processor (415a), the common processor 236 sends a list of configurations to the API 28 (414h), which is subsequently sent to the GUI 26 (415b).

The user 12 sends selected configurations to the GUI 26. The GUI 26 sends a message to clone the selected configurations to the API 28 (414j). The API 28 sends a command to clone the selected configurations to the common processor 236 (414k). The common processor 236 validates the command to clone the selected configurations (414l) (e.g., validates parameters). The common processor 236 sends the cloned configurations to the data accessor 234 (414m).

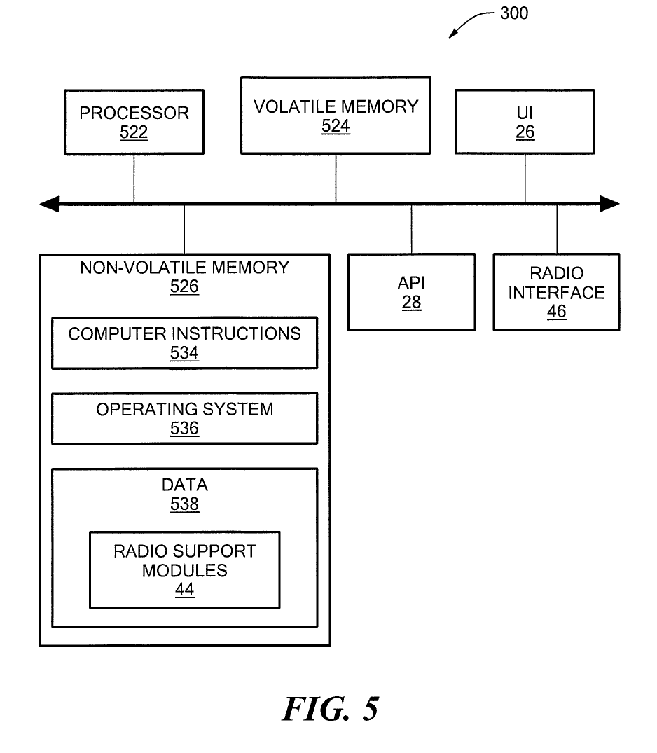

Referring to FIG. 5, a computer 500 includes a processor 522, a volatile memory 524, a non-volatile memory 526 (e.g., hard disk), the GUI 26 (e.g., a mouse, a keyboard, a display, touch screen, for example), the API 28 and the radio interface 46. The non-volatile memory 526 stores computer instructions 534, an operating system 536 and data 538 including the radio support modules 44, for example. In one example, the computer instructions 534 are executed by the processor 522 out of volatile memory 524 to perform all or part of the process 100. In one example, the computer 500 is a modem. In one example, the radio interface 46 includes at least one of a USB port, a serial port or any other port to receive the connector 22.

Process 100 is not limited to use with the hardware and software of FIG. 5; process 100 may find applicability in any computing or processing environment and with any type of machine or set of machines that is capable of running a computer program. Process 100 may be implemented in hardware, software, or a combination of the two. Process 100 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform the process 100 and to generate output information.

The system may be implemented, at least in part, via a computer program product, (e.g., in a machine-readable storage device), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform process 100. Process 100 may also be implemented as a machine-readable storage medium, configured with a computer program, where upon execution, instructions in the computer program cause the computer to operate in accordance with process 100.

The processes described herein are not limited to the specific embodiments described. For example, the process 100 is not limited to the specific processing order of FIG. 2, respectively. Rather, any of the processing blocks of FIG. 2 may be re-ordered, combined or removed, performed in parallel or in serial, as necessary, to achieve the results set forth above.

The processing blocks in FIG. 2 associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Though only three radio types 24a-24c and three corresponding radio type configuration modules 44a-44c are described the number of radio types 24 and corresponding radio configuration modules 44 each are not limited to exactly three (g., for example, fewer than or more than three of the radio types 24 and the radio configuration modules 44 may be used). In other examples, more radio support modules 44 may be available than radio types 24 connected to the radio configuration module 20.

Elements of different embodiments described herein may be combined to form other embodiments not specifically set forth above. Other embodiments not specifically described herein are also within the scope of the following claims.

Elements of different embodiments described herein may be combined to form other embodiments not specifically set forth above.

What is claimed is:

1. A method comprising:
using a processor to:
receive a request to configure a first radio having a first type;
obtain a first configuration type used to configure the first radio; and
configure a first radio using the first configuration type.

2. The method of claim 1 wherein using the processor to receive the request comprises using the processor to receive the request from an application.

3. The method of claim 1 wherein the request is a first request, and
wherein using the processor further comprises using the processor to:
receive a second request to configure a second radio having a second type;
obtain a second configuration type from the machine-readable storage medium to configure the second radio; and
configure a second radio using the second configuration type.

4. The method of claim 3 wherein the processor configured to receive a second request comprises the processor being further configured to receive a second request from the application.

5. The method of claim 3 wherein the application is a first application, and
wherein the processor configured to receive a second request comprises the processor being further configured to receive a second request from a second application.

6. The method of claim 1 wherein using the processor further comprises using the processor to validate the request

7. An article comprising a machine-readable storage medium that stores executable instructions to configure radios, the executable instructions causing a machine to:
receive a request to configure a first radio having a first type;
obtain a first configuration type to configure the first radio; and
configure a first radio using the first configuration type.

8. The article of claim 7 wherein the instructions to receive the request comprises instructions to receive the request from an application.

9. The article of claim 7 wherein the request is a first request, and
wherein the instructions further comprises instructions to:
receive a second request to configure a second radio having a second type;
obtain a second configuration type from the machine-readable storage medium to configure the second radio; and
configure a second radio using the second configuration type.

10. The article of claim 9 wherein the instructions to receive a second request comprises instructions to receive a second request from the application.

11. The article of claim 9 wherein the application is a first application, and
wherein the instructions to receive a second request comprises instructions to receive a second request from a second application.

12. The article of claim 7 wherein the instructions further comprises instructions to validate the request.

13. A radio configuration module; comprising:
an application program interface configured to receive radio configuration requests for a plurality of radio types from a host application;
a storage medium to store configuration types corresponding to the plurality of radio types; and
a processor configured to:
receive the radio configuration requests;
configure radios based on the configuration types stored in the storage medium.

14. The module of claim 13 wherein the module is configured to be connected to the radios by at least one cable.

15. The module of claim 14 wherein the at least one cable is a TacLink® 3300 cable.

16. The module of claim 13 wherein the module is connected the host applications through one of the Internet, a wide area network and a local area network.

17. The module of claim 13 wherein the module is connected to one or more of a PRC-117F radio, a PRC-152 radio and a PRC-148 radio.
